(19) United States
(12) Patent Application Publication
(10) Pub. No.: US 2026/0201289 A1
(43) Pub. Date: Jul. 16, 2026

(54) SYSTEM AND METHOD FOR CREATING SPARKLING LIQUOR

(71) Applicant: Rosenstam & Lindberger Invest AB, Stockholm (SE)

(72) Inventors: Björn CAMITZ, Saltsjö-Boo (SE); Jesper CAMITZ, Urrugne (FR)

(21) Appl. No.: 19/138,307

(22) PCT Filed: Dec. 12, 2023
(86) PCT No.: PCT/SE2023/051244

§ 371 Date: Jun. 12, 2025

(30) Foreign Application Priority Data
Dec. 12, 2022 (SE) 2251444-2

(51) Int. Cl. C12G 3/04; B01F 23/232; B01F 23/237; B01F 25/43; B01F 101/16; B67D 1/00; C12G 3/021

(52) U.S. Cl. CPC C12G 3/04; B01F 23/232; B01F 23/237621; B01F 25/43; B67D 1/0069; C12G 3/021; B01F 2101/16

(57) ABSTRACT

An arrangement for creating sparkling liquor includes a vertically extending first pipe portion, and a horizontally extending second pipe portion, where first end of the second pipe portion is connected to top end of the first pipe portion. A liquor inlet and a carbonic acid inlet are arranged at the bottom end of the first pipe portion, which is shaped to ensure liquor that is introduced will always completely fill its cross-section, thereby ensuring liquor introduced through the liquor inlet and carbonic acid introduced through the carbonic acid inlet flow up together through the first pipe portion to infuse carbonic acid into the liquor. A liquor outlet is arranged at second end of the second pipe portion, which is shaped to ensure that liquor flowing along it will not completely fill its cross-section, thereby allowing evacuation from the liquor of all carbonic acid in excess of the carbonic acid that is infused into the liquor.

### TECHNICAL FIELD

The present disclosure relates generally to the creating of sparkling liquor.

### BACKGROUND

The creation of sparkling liquor has been attempted many times, but the end result has not been appealing. Therefore, there is a need for an improved method for creating sparkling liquor.

### SUMMARY

The above described problem is addressed by the claimed arrangement for creating sparkling liquor. The arrangement preferably comprises a vertically extending first pipe portion, comprising a bottom end and a top end, and a horizontally extending second pipe portion, comprising a first end and a second end, where the first end of the second pipe portion is connected to the top end of the first pipe portion. A liquor inlet and a carbonic acid inlet are preferably arranged at the bottom end of the first pipe portion, which by not being tilted more than its width is shaped to ensure that liquor that is introduced into the first pipe portion will always completely fill the cross-section of the first pipe portion, thereby ensuring that as liquor that is introduced into the first pipe portion through the liquor inlet and carbonic acid that is introduced into the first pipe portion through the carbonic acid inlet flow up together through the first pipe portion, carbonic acid is infused into the liquor. A liquor outlet is preferably arranged at the second end of the second pipe portion, which by not being tilted more than the distance between a predetermined maximum liquor level in the second pipe portion and the top of the inside of the second pipe portion is shaped to ensure that liquor flowing along the second pipe portion from the top end of the first pipe portion to the liquor outlet, will not completely fill the cross-section of the second pipe portion, thereby allowing all carbonic acid in excess of the carbonic acid that is infused into the liquor, at the temperature and pressure that is maintained inside the arrangement, to be evacuated from the liquor. This enables the creation of liquor that is sparkling in the same way as champagne.

In embodiments, the arrangement comprises a pump that pumps the liquor to the liquor inlet. The pump is preferably controlled based on the level of liquor in the second pipe portion. The pump may e.g. be controlled to start pumping when the liquor level falls below a predetermined minimum level, and stop pumping when the liquor level reaches the predetermined maximum level.

In embodiments, the arrangement comprises a pressure regulator, e.g. an overpressure valve, arranged in the second pipe portion, in order to maintain a desired pressure inside the second pipe portion by allowing excess carbonic acid to be evacuated.

In embodiments, the liquor is cooled to below 10° C., preferably below 8° C., before being introduced into the first pipe portion. The infusion of the carbonic acid into the liquor is preferably effected at below 10° C.

In embodiments, the liquor is ethyl alcohol with a percentage by volume of alcohol of 35-45%, preferably 37-42%. Such a percentage is suitable for allowing the carbonic acid to become infused into the liquor.

In embodiments, the liquor is vodka based on wheat. Such liquor has an agreeable taste when carbonated. In embodiments, the first pipe portion has a circular cross-section. The first pipe portion may however have any cross-section, e.g. circular, oval, rectangular, squared or rhombic.

In embodiments, the first pipe portion is a substantially straight, vertical pipe. The first pipe portion may be slightly tilted, but it is preferred if the total tilt is in this case less than the width of the first pipe portion. This will allow for an uninterrupted flow of the carbonic acid up through the first pipe portion, without the carbonic acid hitting the walls of the first pipe portion.

In embodiments, the second pipe portion has a circular cross-section. The second pipe portion may however have any cross-section, e.g. circular, oval, rectangular, squared or rhombic.

In embodiments, the second pipe portion is a substantially straight, horizontal pipe. The second pipe portion may be slightly tilted, but it is preferred if the total tilt is in this case less than the distance between the maximum liquor level in the second pipe portion and the top of the second pipe portion. This will ensure that liquor flowing along the second pipe portion, from the top end of the first pipe portion to the liquor outlet, will not completely fill the cross-section of the second pipe portion.

In embodiments, the liquor outlet is connected to a filling tank. This enables the filling of bottles with the sparkling liquor without air entering the second pipe portion.

In embodiments, the arrangement comprises a plurality of first and second pipe portions. The first end of each second pipe portion is in this case preferably connected to the top end of a corresponding first pipe portion, and the liquor outlet of each second pipe portion is preferably connected to the filling tank. This is a simple way of scaling up production in the arrangement.

The above described problem is also addressed by the claimed method for creating sparkling liquor. The method preferably comprises: introducing liquor through a liquor inlet into a bottom end of a vertically extending first pipe portion of an arrangement, which vertically extending first pipe portion is not tilted more than its width; introducing carbonic acid through a carbonic acid inlet into the bottom end of the vertically extending first pipe portion of the arrangement; controlling the flow of liquor so that the liquor that is introduced into the first pipe portion through the liquor inlet completely fills the cross-section of the first pipe portion, thereby ensuring that as the liquor and the carbonic acid flow up together from the bottom end to a top end of the vertically extending first pipe portion, carbonic acid is infused into the liquor; and controlling the flow of liquor through a horizontally extending second pipe portion of the arrangement, which horizontally extending second pipe portion is not tilted more than the distance between a predetermined maximum liquor level in the second pipe portion and the top of the inside of the second pipe portion, so that liquor flowing from a first end connected to the top end of the first pipe portion to a liquor outlet at a second end of the second pipe portion, does not completely fill the cross-section of the second pipe portion, thereby allowing all carbonic acid in excess of the carbonic acid that is infused into the liquor, at the temperature and pressure that is maintained inside the arrangement, to be evacuated from the liquor. This enables the creation of liquor that is sparkling in the same way as champagne.

In embodiments, the method comprises controlling a pump that pumps the liquor to the liquor inlet based on the level of the liquor in the second pipe portion. The controlling of the pump may e.g. involve starting the pump when the liquor level falls below a predetermined minimum level, and stopping the pump when the liquor level reaches the predetermined maximum level.

In embodiments, the method comprises maintaining a desired pressure inside the second pipe portion by allowing excess carbonic acid to be evacuated through a pressure regulator, e.g. an overpressure valve, arranged in the second pipe portion.

In embodiments, the method comprises cooling the liquor to below 10° C., preferably below 8° C., before introducing it into the first pipe portion. The infusion of the carbonic acid into the liquor is preferably effected at below 10° C.

In embodiments, the method comprises using ethyl alcohol with a percentage by volume of alcohol of 35-45%, preferably 37-42%, as the liquor. Such a percentage is suitable for allowing the carbonic acid to become infused into the liquor.

In embodiments, the method comprises using vodka based on wheat as the liquor. Such liquor has an agreeable taste when carbonated.

In embodiments, the method comprises arranging the first pipe portion to have a circular cross-section. The first pipe portion may however have any cross-section, e.g. circular, oval, rectangular, squared or rhombic.

In embodiments, the method comprises arranging the first pipe portion as a substantially straight, vertical pipe, which may be slightly tilted, as long as the total tilt is less than the width of the first pipe portion. This will allow for an uninterrupted flow of the carbonic acid up through the first pipe portion, without the carbonic acid hitting the walls of the first pipe portion.

In embodiments, the method comprises arranging the second pipe portion to have a circular cross-section. The second pipe portion may however have any cross-section, e.g. circular, oval, rectangular, squared or rhombic.

In embodiments, the method comprises arranging the second pipe portion as a substantially straight, horizontal pipe, which may be slightly tilted, as long as the total tilt is less than the distance between the maximum liquor level in the second pipe portion and the top of the second pipe portion. This will ensure that liquor flowing along the second pipe portion, from the top end of the first pipe portion to the liquor outlet, will not completely fill the cross-section of the second pipe portion.

In embodiments, the carbonic acid inlet comprises one or more sintered pipes.

In embodiments, the method comprises arranging a filling tank connected to the liquor outlet. This enables the filling of bottles with the sparkling liquor without air entering the second pipe portion.

In embodiments, the method comprises arranging the carbonic acid inlet to comprise one or more sintered pipes.

In embodiments, the method comprises arranging a plurality of first and second pipe portions so that the first end of each second pipe portion is connected to the top end of a corresponding first pipe portion. In this case, the liquor outlet of each of the second pipe portions is preferably arranged to be connected to the filling tank. This is a simple way of scaling up production in the arrangement.

The carbonic acid is prefereably CO₂.

The term “pipe portion” in this application means that the shape is elongated and hollow. The pipe portions may have any cross-section, e.g. circular, oval, rectangular, squared or rhombic. The pipe portions may also have any size.

The definition that the first pipe portion is vertically extending means that it extends in the vertical direction, but it may of course be slightly tilted, and thereby extend also in the horizontal direction. The importance of the first pipe portion being vertically extending is that as the liquor flows upwards through the first pipe portion, the cross-section of the first pipe portion is completely filled with liquor, so that there is no air interacting with the liquor as the carbonic acid flows upwards together with the liquor. As long as the total tilt is less than the width of the first pipe portion, this will allow for an uninterrupted flow of the carbonic acid up through the first pipe portion, without the carbonic acid hitting the walls of the first pipe portion.

The definition that the second pipe portion is horizontally extending means that it extends in the horizontal direction, but it may of course be slightly tilted, and thereby extend also in the vertical direction. The second pipe portion may be straight or curved. The importance of the second pipe portion being horizontally extending is that liquor flowing along the second pipe portion from the top end of the first pipe portion to the liquor outlet will not completely fill the cross-section of the second pipe portion, thus allowing all carbonic acid in excess of the carbonic acid is infused into the liquor at the pressure that is maintained inside the arrangement to be evacuated from the liquor. As long as the total tilt is less than the distance between the maximum liquor level in the second pipe portion and the top of the second pipe portion, this will ensure that liquor flowing along the second pipe portion, from the top end of the first pipe portion to the liquor outlet, will not completely fill the cross-section of the second pipe portion.

The definition that the liquor inlet and the carbonic acid inlet are arranged at the bottom end of the first pipe portion means that they are arranged near the bottom. There may be a small distance between the actual bottom of the first pipe portion and the inlets, and the inlets are not necessarily arranged at the same height in the first pipe portion.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 is a schematic view of an embodiment of an arrangement for creating sparkling liquor, in accordance with one or more embodiments described herein.

FIG. 2 is another schematic view of an embodiment of an arrangement for creating sparkling liquor, in accordance with one or more embodiments described herein.

FIG. 3 is a schematic view of another embodiment of an arrangement for creating sparkling liquor, in accordance with one or more embodiments described herein

FIG. 4 is a schematic flow diagram of a method for creating sparkling liquor, in accordance with one or more embodiments described herein.

Embodiments of the present disclosure and their advantages are best understood by referring to the detailed description that follows. It should be appreciated that like reference numerals are used to identify like elements illustrated in one or more of the figures.

### DETAILED DESCRIPTION

### Introduction

The present disclosure relates generally to an arrangement and a method for creating sparkling liquor. Embodiments of the disclosed solution are presented in more detail in connection with the figures.

### Architecture of the Arrangement

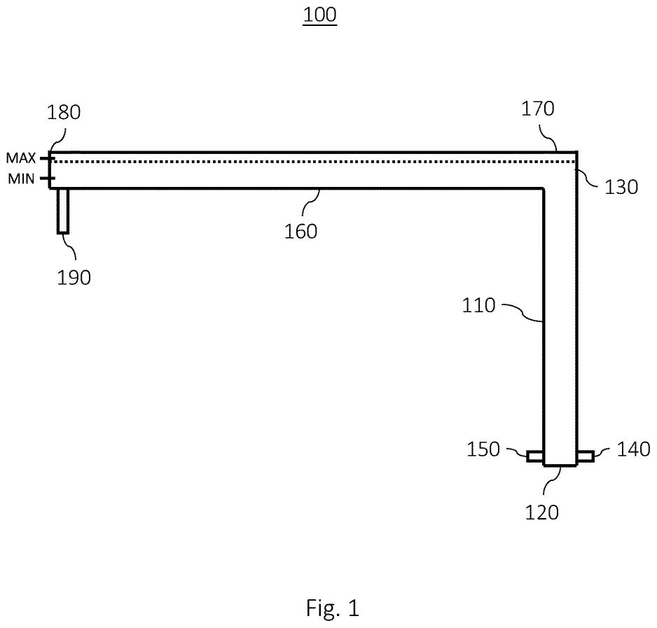

FIG. 1 is a schematic view of an embodiment of an arrangement 100 for creating sparkling liquor. The arrangement 100 comprises a vertically extending first pipe portion 110, comprising a bottom end 120 and a top end 130, and a horizontally extending second pipe portion 160, comprising a first end 170 and a second end 180, where the first end 170 of the second pipe portion 160 is connected to the top end 130 of the first pipe portion 110. The pipe portions are elongated and hollow, but may have any cross-section, e.g. circular, oval, rectangular, squared or rhombic. The pipe portions may also have any size.

At the bottom end 120 of the first pipe portion 110, two inlets, a liquor inlet 140 and a carbonic acid inlet 150, are arranged. The shape of the first pipe portion 110, together with the arrangement of the inlets 140, 150 at its bottom end 120, means that liquor that is introduced into first pipe portion 110 will completely fill the cross-section of the first pipe portion 110, thereby ensuring that as the liquor and the carbonic acid that is introduced through the respective inlets 140, 150 flow up together through the first pipe portion 110, carbonic acid is infused into the liquor. The cross-section of the first pipe portion 110 may have any shape, but may e.g. be circular. The first pipe portion 110 may e.g. be a substantially straight, vertical pipe, or a slightly tilted vertical pipe.

The first pipe portion 110 should be shaped to ensure that liquor that is introduced at its bottom end will completely fill its cross-section. This will typically be the case as long as the first pipe portion 110 continuously extends in the vertical direction, and the vertical extension of the first pipe portion 110 is bigger than the width of the pipe. The first pipe portion 110 may be slightly tilted, but it is preferred if the total tilt is in this case less than the width of the first pipe portion 110. This will allow for an uninterrupted flow of the carbonic acid up through the first pipe portion 110, without the carbonic acid hitting the walls of the first pipe portion 110.

At the second end 180 of the second pipe portion 160, a liquor outlet 190 is arranged. The shape of the second pipe portion 160, together with the arrangement of the liquor outlet 190 at its second end, ensures that liquor flowing along the second pipe portion 160, from the top end 130 of the first pipe portion 110 to the liquor outlet 190, will not completely fill the cross-section of the second pipe portion 160, thereby allowing all carbonic acid in excess of the carbonic acid that is infused into the liquor, at the temperature and pressure that is maintained inside the arrangement 100, to be evacuated from the liquor. The cross-section of the second pipe portion 160 may have any shape, but may e.g. be circular. The second pipe portion 160 may e.g. be a substantially straight, horizontal pipe, or a slightly tilted horizontal pipe. It is preferred if the total tilt is in this case less than the distance between the maximum liquor level in the second pipe portion and the top of the second pipe portion. This will ensure that liquor flowing along the second pipe portion, from the top end of the first pipe portion to the liquor outlet, will not completely fill the cross-section of the second pipe portion.

The second pipe portion 160 should be shaped to ensure that liquor flowing along it will not completely fill the cross-section of the second pipe portion 160. This will typically be the case as long as the second pipe portion 160 continuously extends in the horizontal direction, and the vertical extension of the second pipe portion 160 is smaller than the distance between the top of the liquor and the top of the inside of the second pipe portion 160. The second pipe portion 160 should be long enough to allow the liquor to “settle”, after having typically become quite foamy when rising up through the first pipe portion 110 together with the carbonic acid.

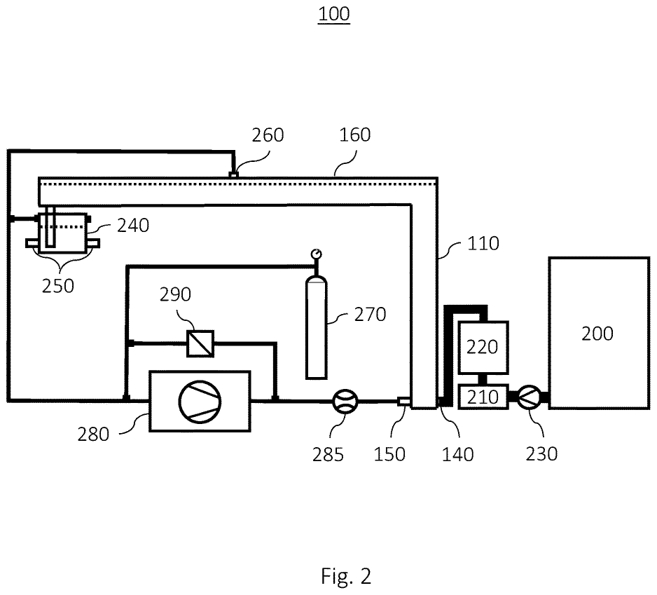

FIG. 2 is another schematic view of an embodiment of an arrangement 100 for creating sparkling liquor. As shown in FIG. 2, the arrangement 100 preferably comprises also tanks for holding the liquor before and after it flows through the first pipe portion 110 and the second pipe portion 160. FIG. 2 shows a liquor tank 200, that may have any suitable size, e.g. 1 m³ (1000 liters). Since the liquor does not need to be stored at any particular temperature, it is preferably cooled as it is pumped from the liquor tank 200 to the liquor inlet 140, e.g. using a flow-through cooler 210, e.g. in the form of a heat exchanger. The liquor is preferably cooled to below 10° C., preferably 8° C., since the infusion of the carbonic acid into the liquor is preferably effected at below 10° C.

The pump 230 is preferably controlled based on the liquor level in the second pipe portion 160. It is preferably ensured that there is always liquor in the second pipe portion 160, but the liquor level cannot be allowed to become so high that liquor flowing along the second pipe portion 160 will completely fill its cross-section. The liquor level in the second pipe portion 160 will depend both on the amount of liquor entering the liquor inlet 140 and the amount of liquor flowing out of the liquor outlet 190. As soon as the liquor level in the second pipe portion 160 drops below a predetermined minimum level, the pump 230 should be started, so that new liquor will enter the liquor inlet 140. As soon as the liquor level second pipe portion 160 reaches a predetermined maximum level, the pump 230 should be stopped. The pump 230 may thus be controlled to start pumping when the liquor level falls below a predetermined minimum level, and stop pumping when the liquor level reaches a predetermined maximum level. The minimum and maximum levels are schematically illustrated in FIG. 1.

Since such an intermittent pumping of the liquor through the flow-through cooler 210 will cause the temperature of the liquor to vary over time, the liquor is preferably stored in an intermediate tank 220, in order to even out its temperature. The intermediate tank may have any suitable size, e.g. 40 liters. In order for the liquor inside the first pipe portion 110 to always be at a temperature well below 10° C., it is preferred to cool the liquor to a much lower temperature, such as e.g. 4° C., in the flow-through cooler 210.

FIG. 2 also shows the use of a carbonic acid supply system comprising a gas tank 270, which supplies carbonic acid to the carbonic acid inlet 150. In order to maintain the pressure in the second pipe portion 160 at a desired pressure, a pressure regulator 260 (e.g. an overpressure valve, where excess carbonic acid can be evacuated) is preferably arranged in the second pipe portion 160. It is possible to feed the carbonic acid inlet 150 with carbonic acid directly from the gas tank 270, and allowing all excess carbonic acid to simply evacuate through the pressure regulator 260. However, it is much more efficient to arrange the carbonic acid supply system to comprise a compressor 280, and connect the pressure regulator 260 to the compressor 280, as illustrated in FIG. 2. In this way, excess carbonic acid can be re-used, and new carbonic acid from the gas tank 270 need only be supplied in the amount that is consumed in the arrangement 100.

The gas tank 270 is preferably arranged with a pressure control valve, which regulates the flow of CO₂ from the gas tank 270 for the pressure to remain constant. The sparkling liquor should preferably contain about 10 g CO₂ per liter liquor, and it is therefore desirable to control the flow of carbonic acid based on the flow of liquor. To this end, a flow meter 285 is preferably arranged between the compressor 280 and the carbonic acid inlet 150, to monitor the flow of carbonic acid. There is preferably also a flow meter that monitors the flow of liquor, e.g. arranged in connection with the pump 230. The outputs from these flow meters can be used to control the flow of carbonic acid based on the flow of liquor.

In order to control the flow of carbonic acid, a flow control valve 290 may be arranged in a feedback loop around the compressor 280. The output from the flow meter 285 may in this case be used to regulate the flow control valve 290, to allow more carbonic acid to flow through the feedback loop if the flow measured by the flow meter 285 is too high. The carbonic acid that flow through the feedback loop may then be fed back to the compressor 280, together with carbonic acid from the pressure regulator 260 and from the gas tank 270.

The carbonic acid inlet 150 is preferably arranged to supply the carbonic acid as very small bubbles, and in more than one position at the bottom end 120 of the first pipe portion 110. The more atomized the carbonic acid is when supplied, the easier it will be for it to be infused into the liquor, since the contact surface between the carbonic acid and the liquor will be larger. One way of achieving a very atomized supply of carbonic acid is to supply the carbonic acid through one or more sintered pipes, by the carbonic acid inlet 150 comprising one or more sintered pipes. The sintering of the pipes makes them porous, which creates a large number of extremely small (typically 1-10 μm) openings all around the pipes. With openings that are that narrow, pressure will typically be required to push the carbonic acid through the openings.

As shown in FIG. 2, the arrangement 100 preferably comprises also a filling tank 240, connected to the liquor outlet 190. If the fill level of the filling tank 240 is maintained above the opening of the liquor outlet 190 inside the filling tank, this ensures that no air enters into the second pipe portion 160. The carbonic acid supply system may be connected also to the filling tank 240, to maintain the pressure inside the filling tank 240.

The filling tank 240 preferably comprises a number of filling outlets 250, preferably arranged close to the bottom of the filling tank 240, for filling bottles with the sparkling liquor. A small filling tank 240 of e.g. 20 liters may e.g. comprise six or eight filling outlets 250, while a larger filling tank 240 may comprise twenty, or more.

When a bottle is to be filled, it is connected to a filling outlet 250. The filling outlet 250 preferably contains a mechanism that evacuates the air inside the bottle, and puts the bottle at the same pressure as the filling tank 240. Such a mechanism may e.g. comprise a pipe that evacuates the air inside the bottle into the space above the fill level of the filling tank 240. The filling tank 240 preferably comprises a one-way air valve (illustrated in the top right corner of the filling tank 240), through which the air from the bottles may be evacuated. Once a bottle has reached the same pressure as the filling tank 240, liquor will flow gently into the bottle.

The liquor is preferably ethyl alcohol with a percentage by volume of alcohol of 35-45%, preferably 37-42%, since such a percentage is suitable for allowing the carbonic acid to become infused into the liquor. The liquor may e.g. be vodka based on wheat, since such liquor has an agreeable taste when carbonated. The liquor should preferably be substantially clean from pollutions, as these may affect the carbonization process.

The pressure inside the first and second pipe portions 110, 160 is preferably maintained above 2.5 bar. Since the temperature inside the first and second pipe portions 110, 160 is preferably maintained at below 10° C., this corresponds to a pressure of around 4 bar at room temperature, which is suitable for sparkling liquor.

One example of suitable dimensions for the arrangement 100 is that the first pipe portion 110 is a 2.5 m long pipe having a diameter of 150 mm, and the second pipe portion 160 is a 9 m long pipe having a diameter of 150 mm. Such a system may e.g. be able to carbonate about 4 liters of vodka per minute. It is of course possible to use many different dimensions for the arrangement 100.

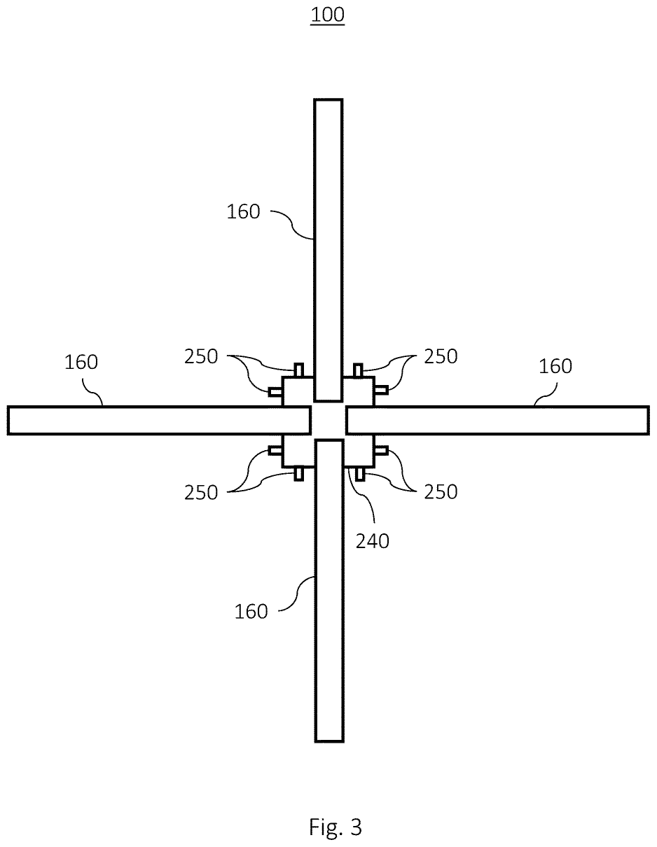

For an arrangement 100 that produces larger quantities of sparkling liquor, it is also possible to use a number of first 110 and second 160 pipe portions, where the second pipe portions 160 are connected to the same filling tank 240. An embodiment of such an arrangement 100 is schematically illustrated in FIG. 3. In this embodiment, four second 160 pipe portions are connected to the same filling tank 240, which comprises a large number of filling outlets 250. As in the above described embodiments, the first end 170 of each second pipe portion 160 is in this case connected to the top end 130 of a corresponding first pipe portion 110. Preferably, each first pipe portion 110 is connected to a separate liquor tank 200, and has its own equipment such as flow-through cooler 210, intermediate tank 220, pump 230, and carbonic acid supply system. However, some, or all, of this equipment may also be shared. This is a simple way of scaling up production in the arrangement 100. An arrangement 100 of this type may of course comprise any number of first 110 and second 160 pipe portions connected to the same filling tank 240.

### Method Embodiments

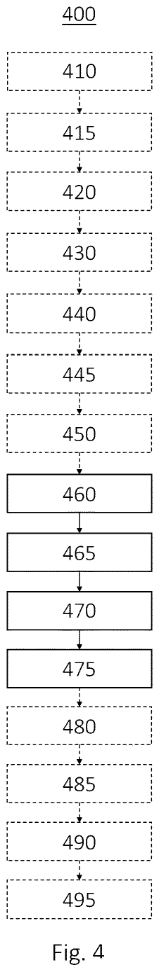

FIG. 4 is a flow diagram of embodiments of a method for creating sparkling liquor. In accordance with one or more embodiments, the method 400 comprises:
Step 460: introducing liquor through a liquor inlet 140 into a bottom end 120 of a vertically extending first pipe portion 110 of an arrangement 100.
Step 465: introducing carbonic acid through a carbonic acid inlet 150 into the bottom end 120 of the vertically extending first pipe portion 110 of the arrangement 100.
Step 470: controlling the flow of liquor so that the liquor that is introduced into the first pipe portion 110 through the liquor inlet 140 completely fills the cross-section of the first pipe portion 110, thereby ensuring that as the liquor and the carbonic acid flow up together from the bottom end 120 to a top end 130 of the vertically extending first pipe portion 110, carbonic acid is infused into the liquor.
Step 475: controlling the flow of liquor so that liquor flowing through a horizontally extending second pipe portion 160 of the arrangement 100, from a first end 170 connected to the top end 130 of the first pipe portion 110 to a liquor outlet 190 at a second end 180 of the second pipe portion 160, does not completely fill the cross-section of the second pipe portion 160, thereby allowing all carbonic acid in excess of the carbonic acid that is infused into the liquor at the temperature and pressure that is maintained inside the arrangement 100 to be evacuated from the liquor.

This enables the creation of liquor that is sparkling in the same way as champagne.

All of these steps may be effected simultaneously.

In one or more embodiments, the method 400 further comprises one or more of the following steps, effected in any order:
Step 410: arranging the first pipe portion 110 as a substantially straight, vertical pipe, with a circular cross-section, and the second pipe portion 160 as a substantially straight, horizontal pipe, with a circular cross-section. The first and second pipe portions may have any cross-section, e.g. circular, oval, rectangular, squared or rhombic. The first pipe portion may be slightly tilted, but it is preferred if the total tilt is in this case less than the width of the first pipe portion. This will allow for an uninterrupted flow of the carbonic acid up through the first pipe portion, without the carbonic acid hitting the walls of the first pipe portion. The second pipe portion may also be slightly tilted, but it is preferred if the total tilt is in this case less than the distance between the maximum liquor level in the second pipe portion and the top of the second pipe portion. This will ensure that liquor flowing along the second pipe portion, from the top end of the first pipe portion to the liquor outlet, will not completely fill the cross-section of the second pipe portion.
Step 415: arranging the carbonic acid inlet 150 to comprise one or more sintered pipes.
Step 420: arranging a filling tank 240 connected to the liquor outlet 190. This enables the filling of bottles with the sparkling liquor without air entering the second pipe portion.
Step 430: arranging a plurality of first 110 and second 160 pipe portions so that the first end 170 of each second pipe portion 160 is connected to the top end 130 of a corresponding first pipe portion 110, and so that the liquor outlet 190 of each second pipe portion 160 is connected to the filling tank 240. This is a simple way of scaling up production in the arrangement.
Step 440: using ethyl alcohol with a percentage by volume of alcohol of 35-45%, preferably 37-42%, as the liquor. Such a percentage is suitable for allowing the carbonic acid to become infused into the liquor.
Step 445: using vodka based on wheat as the liquor. Such liquor has an agreeable taste when carbonated.
Step 450: cooling the liquor to below 10° C., preferably below 8° C., before introducing 460 it into the first pipe portion 110. The infusion of the carbonic acid into the liquor is preferably effected at below 10° C.
Step 480: controlling a pump 230 that pumps the liquor to the liquor inlet 140 based on the level of the liquor in the second pipe portion 160.
Step 485: starting the pump 230 when the liquor level falls below a predetermined minimum level.
Step 490: stopping the pump 230 when the liquor level reaches a predetermined maximum level.
Step 495: maintaining a desired pressure inside the second pipe portion 160 by allowing excess carbonic acid to be evacuated through a pressure regulator 260, e.g. an overpressure valve, arranged in the second pipe portion 160.

These steps, when applicable, may be effected in any order that makes technical sense.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Accordingly, the scope of the invention is defined only by the claims.

1. An arrangement for creating sparkling liquor, the arrangement comprising:
a vertically extending first pipe portion comprising a bottom end and a top end;
a horizontally extending second pipe portion comprising a first end and a second end, where the first end of the second pipe portion is connected to the top end of the first pipe portion;
a liquor inlet and a carbonic acid inlet arranged at the bottom end of the first pipe portion, which by not being tilted more than its width is shaped to ensure that liquor that is introduced into the first pipe portion will always completely fill the cross-section of the first pipe portion, thereby ensuring that as liquor that is introduced into the first pipe portion through the liquor inlet and carbonic acid that is introduced into the first pipe portion through the carbonic acid inlet flow up together through the first pipe portion, carbonic acid is infused into the liquor; and
a liquor outlet arranged at the second end of the second pipe portion, which by not being tilted more than the distance between a predetermined maximum liquor level in the second pipe portion and the top of the inside of the second pipe portion is shaped to ensure that liquor flowing along the second pipe portion, from the top end of the first pipe portion to the liquor outlet, will not completely fill the cross-section of the second pipe portion, thereby allowing all carbonic acid in excess of the carbonic acid that is infused into the liquor, at the temperature and pressure that is maintained inside the arrangement, to be evacuated from the liquor.

2. The arrangement according to claim 1, further comprising a pump that pumps the liquor to the liquor inlet, wherein the pump is controlled based on the liquor level in the second pipe portion.

3. The arrangement according to claim 2, wherein the pump is controlled to start pumping when the liquor level falls below a predetermined minimum level, and stop pumping when the liquor level reaches the predetermined maximum level.

4. The arrangement according to claim 1, further comprising a pressure regulator, arranged in the second pipe portion, in order to maintain a desired pressure inside the second pipe portion by allowing excess carbonic acid to be evacuated.

5. The arrangement according to claim 1, wherein the liquor is cooled to below 10° C. before being introduced into the first pipe portion.

6. The arrangement according to claim 1, wherein the liquor is ethyl alcohol with a percentage by volume of alcohol of 35-45%.

7. The arrangement according to claim 1, wherein the liquor is vodka based on wheat.

8. The arrangement according to claim 1, wherein the first pipe portion is a substantially straight, vertical pipe with a circular cross-section, and the second pipe portion is a substantially straight, horizontal pipe with a circular cross-section.

9. The arrangement according to claim 1, wherein the carbonic acid inlet comprises one or more sintered pipes.

10. The arrangement according to claim 1, wherein the liquor outlet (190) is connected to a filling tank (240).

11. The arrangement according to claim 10, comprising a plurality of first and second pipe portions,
wherein the first end of each second pipe portion is connected to the top end of a corresponding first pipe portion, and
wherein the liquor outlet of each second pipe portion is connected to said filling tank.

12. A method for creating sparkling liquor, the method comprising:
introducing liquor through a liquor inlet into a bottom end of a vertically extending first pipe portion of an arrangement, which vertically extending first pipe portion is not tilted more than its width;
introducing carbonic acid through a carbonic acid inlet into the bottom end of the vertically extending first pipe portion of the arrangement;
controlling the flow of liquor so that the liquor that is introduced into the first pipe portion through the liquor inlet completely fills the cross-section of the first pipe portion, thereby ensuring that as the liquor and the carbonic acid flow up together from the bottom end to a top end of the vertically extending first pipe portion, carbonic acid is infused into the liquor; and
controlling the flow of liquor through a horizontally extending second pipe portion of the arrangement, which horizontally extending second pipe portion is not tilted more than the distance between a predetermined maximum liquor level in the second pipe portion and the top of the inside of the second pipe portion, so that liquor flowing from a first end connected to the top end of the first pipe portion to a liquor outlet at a second end of the second pipe portion, does not completely fill the cross-section of the second pipe portion, thereby allowing all carbonic acid in excess of the carbonic acid that is infused into the liquor, at the temperature and pressure that is maintained inside the arrangement, to be evacuated from the liquor.

13. The method according to claim 12, further comprising controlling a pump that pumps the liquor to the liquor inlet based on the level of the liquor in the second pipe portion.

14. The method according to claim 13, wherein the controlling of the pump involves starting the pump when the liquor level falls below a predetermined minimum level, and stopping the pump when the liquor level reaches the predetermined maximum level.

15. The method according to claim 12, further comprising maintaining a desired pressure inside the second pipe portion by allowing excess carbonic acid to be evacuated through a pressure regulator arranged in the second pipe portion.

16. The method according to claim 12, further comprising cooling the liquor to below 10° C. before introducing it into the first pipe portion.

17. The method according to claim 12, further comprising using ethyl alcohol with a percentage by volume of alcohol of 35-45% as the liquor.

18. The method according to claim 12, further comprising using vodka based on wheat as the liquor.

19. The method according to claim 12, further comprising arranging the first pipe portion as a substantially straight, vertical pipe, with a circular cross-section, and the second pipe portion as a substantially straight, horizontal pipe, with a circular cross-section.

20. The method according to claim 12, further comprising arranging the carbonic acid inlet to comprise one or more sintered pipes.

21. The method according to claim 12, further comprising arranging a filling tank connected to the liquor outlet.

22. The method according to claim 21, further comprising arranging a plurality of first and second pipe portions so that the first end of each second pipe portion is connected to the top end of a corresponding first pipe portion, and so that the liquor outlet of each second pipe portion is connected to said filling tank.
